(19) United States
(12) Patent Application Publication
(10) Pub. No.: US 2026/0046710 A1
(43) Pub. Date: Feb. 12, 2026

(54) PATH HANDOVER METHOD, AND APPARATUS

(71) Applicant: BEIJING XIAOMI MOBILE SOFTWARE CO., LTD., Beijing (CN)

(72) Inventor: Xing YANG, Beijing (CN)

(21) Appl. No.: 19/100,756

(22) PCT Filed: Aug. 5, 2022
(86) PCT No.: PCT/CN2022/110704

§ 371 Date: Feb. 3, 2025

(51) Int. Cl. H04W 36/00; H04W 36/24

(52) U.S. Cl. CPC H04W 36/0079; H04W 36/249

(57) ABSTRACT

A path handover method is provided. The method includes: in response to an execution of a path handover to a target node being triggered, determining whether a preset condition is satisfied; and in response to the preset condition being satisfied, sending first indication information to a network device, the first indication information being used for indicating auxiliary information for handover to the target node.

### CROSS-REFERENCE TO RELATED APPLICATION

The present application is a U.S. national phase of International Application No. PCT/CN2022/110704, filed with the State Intellectual Property Office of P.R. China on Aug. 5, 2022, the content of which is incorporated herein by reference in its entirety for all purposes.

### FIELD

The present disclosure relates to the field of communication technology, and particularly to a path handover method and apparatus.

### BACKGROUND

When a terminal is handed over to a target cell based on a handover command sent by a network device or a case of a handover condition being satisfied, a handover failure can occur, which may be caused by the network device sending the handover command too late, or by an unreasonable handover condition configured by the network.

### SUMMARY

According to a first aspect of embodiments of the present disclosure, there is provided a path handover method, performed by a terminal, including: determining whether a preset condition is satisfied, in response to an execution of a path handover to a target node being triggered; sending first indication information to a network device, in response to the preset condition being satisfied, in which the first indication information is used to indicate auxiliary information for handover to the target node.

According to a second aspect of embodiments of the present disclosure, there is provided a path handover method, performed by a network device, including: receiving first indication information sent by a terminal, in which the first indication information is used to indicate auxiliary information for the terminal to hand over to a target node in a case where the terminal is triggered to execute a path handover to the target node and a preset condition is satisfied.

According to a third aspect of embodiments of the present disclosure, there is provided a communication apparatus, including: a processor and a memory, wherein the memory stores computer programs, and when the computer programs stored in the memory are executed by the processor, the method described in the first aspect is executed by the communication apparatus.

According to a fourth aspect of embodiments of the present disclosure, there is provided a communication apparatus, including: a processor and a memory, wherein the memory stores computer programs, and when the computer programs stored in the memory are executed by the processor, the method described in the second aspect is executed by the communication apparatus.

### BRIEF DESCRIPTION OF THE DRAWINGS

In order to illustrate the technical solutions in the present disclosure or the prior art more clearly, the accompanying drawings required for use in the present disclosure or the prior art will be described below.

FIG. 1 is a schematic diagram of a communication system according to an embodiment of the present disclosure;

FIG. 2 is a flow chart of a path handover method according to an embodiment of the present disclosure;

FIG. 3 is a flow chart of another path handover method according to an embodiment of the present disclosure;

FIG. 4 is a flow chart of yet another path handover method according to an embodiment of the present disclosure;

FIG. 5 is a flow chart of another path handover method according to an embodiment of the present disclosure;

FIG. 6 is a flow chart of another path handover method according to an embodiment of the present disclosure;

FIG. 7 is a flow chart of another path handover method according to an embodiment of the present disclosure;

FIG. 8 is a block diagram of a communication apparatus according to an embodiment of the present disclosure;

FIG. 9 is a block diagram of another communication apparatus according to an embodiment of the present disclosure;

FIG. 10 is a block diagram of a chip according to an embodiment of the present disclosure.

### DETAILED DESCRIPTION

To facilitate understanding, the terms involved in the present disclosure are first introduced.

### 1. Conditional Handover (CHO)

A network device configures a CHO handover command for a terminal in advance, including a handover target cell configuration and a handover trigger condition. The terminal stores a received CHO handover command and performs a radio resource management (RRM) measurement to determine whether a handover condition is satisfied. When the handover trigger condition is satisfied, the terminal initiates a handover procedure to a target cell.

### 2. Relay

The terminal can communicate with the network device indirectly but through a relay, such as a relay terminal. A terminal that is not connected with the network device is referred to as a remote user equipment (UE), and a terminal that provides a relay functionality can be referred to as a relay UE.

A direct connection between the terminal and the network device is referred to as a direct link. A connection between the terminal and the network device through the relay UE is referred to as an indirect link.

### 3. Target Node

The target node is a target relay or a target cell corresponding to a handover command or a handover condition.

### 4. Artificial Intelligence (AI)

Artificial Intelligence (AI) is a discipline that studies how to make computers simulate certain thought processes and intelligent behaviors of humans. Machine learning algorithm is currently one of the most important methods for implementing the AI technology. Machine learning can obtain a model through a large amount of training data, and a prediction can be made on events using the model. By training an AI model with big data related to handover, a resulting AI model can predict a success probability or a failure probability of handover to a certain cell based on a real-time network environment of the terminal.

In order to better understand a path handover method according to the embodiments of the present disclosure, a communication system to which the embodiments of the present disclosure are applicable is described below.

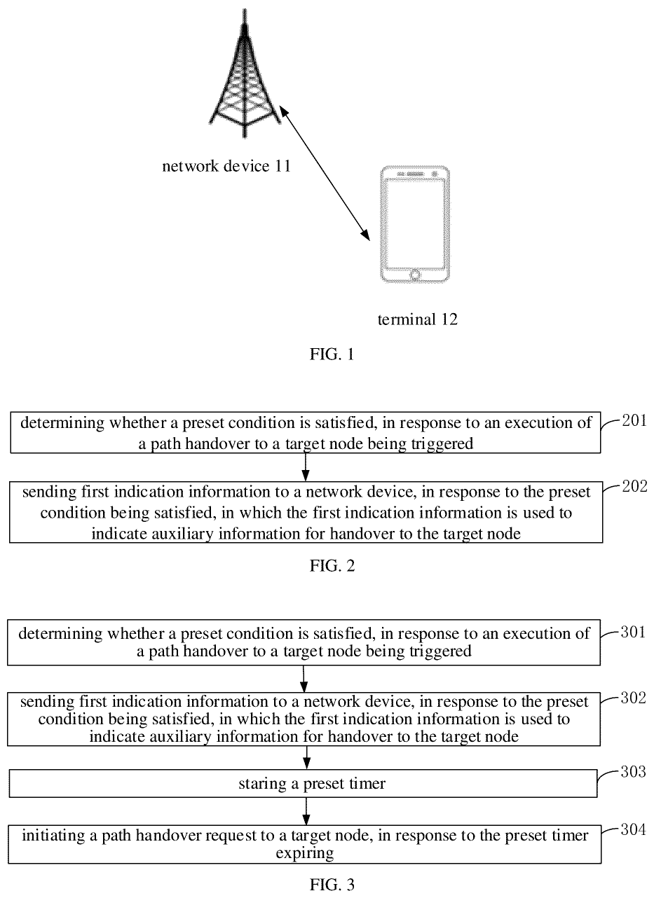

Please refer to FIG. 1, which is a schematic diagram of a communication system according to an embodiment of the present disclosure. The communication system can include, but is not limited to, one network device and one terminal. The number and form of the devices shown in FIG. 1 are for illustrative purposes only and do not constitute a limitation of the present disclosure. In practical applications, there can be two or more network devices, as well as two or more terminals. FIG. 1 shows a communication system including, for example, a network device 11 and a terminal 12.

It should be noted that the technical solution in the embodiments of the present disclosure can be applied to various communication systems, for example, long term evolution (LTE) system, 5th generation (5G) mobile communication system, 5G new radio (NR) system, or other new mobile communication systems in the future.

The network device 11 in the embodiments of the present disclosure is an entity on the network side used for transmitting or receiving a signal. For example, the network device 11 can be an evolved NodeB (eNB), a transmission reception point (TRP), a next generation NodeB (gNB) in an NR system, a base station in other future mobile communication systems, or an access point in a wireless fidelity (WiFi) system. A specific technology and device form adopted by the network device in the embodiments of the present disclosure are not limited. The network device provided in the embodiments of the present disclosure can be composed of a central unit (CU) and a distributed unit (DU), in which the CU can also be referred to as a control unit. A protocol layer of the network device, for example, a base station, may be divided by adopting the CU-DU structure. Some functions of the protocol layer are centrally controlled by the CU, and some or all of remaining functions of the protocol layer are distributed in the DU, which is centrally controlled by the CU.

The terminal 12 in the embodiments of the present disclosure is an entity on the user side, such as a mobile phone, used for receiving or transmitting the signal. The terminal can also be referred to as a terminal, a user equipment (UE), a mobile station (MS), a mobile terminal (MT), etc. The terminal can be a car with communication functions, a smart car, a mobile phone, a wearable device, a Pad, a computer with wireless transmission and reception capabilities, a virtual reality (VR) terminal, an augmented reality (AR) terminal, a wireless terminal in industrial control, a wireless terminal in self-driving, a wireless terminal in remote medical surgery, a wireless terminal in smart grid, a wireless terminal in transportation safety, and a wireless terminal in smart city, a wireless terminal in smart home, etc. A specific technology and device form adopted by the terminal in the embodiments of the present disclosure are not limited.

It should be understood that the communication system in the embodiments of the present disclosure is to more clearly illustrate the technical solution of the embodiments of the present disclosure, and does not constitute a limitation on the technical solution in the embodiments of the present disclosure. Those skilled in the art may know, with the evolution of the system architecture and the emergence of new service scenarios, the technical solution in the embodiments of the present disclosure is also applicable to similar technical problems.

In the system, the terminal can implement the method shown in any of the embodiments of FIG. 2 to FIG. 5 of the present disclosure, and the network device can implement the method shown in the embodiments of FIG. 6 to FIG. 7 of the present disclosure.

It should be understood that the communication system in the embodiments of the present disclosure is to more clearly illustrate the technical solution of the embodiments of the present disclosure, and does not constitute a limitation on the technical solution in the embodiments of the present disclosure. Those skilled in the art may know, with the evolution of the system architecture and the emergence of new service scenarios, the technical solution in the embodiments of the present disclosure is also applicable to similar technical problems.

Usually, in a traditional handover procedure, the network device will first send a handover request to a handover target cell based on a measurement reporting result from the terminal. After the target cell is confirmed, the network device sends a handover command (reconfiguration with sync) to the terminal, in which the handover command carries configuration information of one target cell. Upon receiving the handover command, the terminal initiates a handover procedure to the target cell.

In order to enhance the robustness of handover, a conditional handover (CHO) is proposed, that is, the network device can pre-configure a CHO handover command for the terminal, including a handover target cell configuration and a handover trigger condition. The handover target cell configuration is a reconfiguration message provided by the target cell. The terminal stores the received CHO handover command, performs radio resource management (RRM) measurement, and determines whether a handover condition is satisfied. When the handover trigger condition is satisfied, the terminal initiates the handover procedure to the target cell. In this way, a wireless link handover failure caused by that the network device sends the handover command too late can be avoided. However, a wireless link handover failure may still occur due to an unreasonable handover condition configured by the network device.

The present disclosure mainly proposes a path handover method for situations of the handover failure caused by the network device sending the handover command too late or by the unreasonable handover condition configured by the network. When the terminal is triggered to execute a path handover, it can judge whether a handover to the target node satisfies a preset condition before executing the path handover. If the preset condition is satisfied, the terminal can send, to the network device, auxiliary information for handover to the target node, so that the network device may select a new target node for the terminal or update the handover condition. In this way, the failure of the path handover performed by the terminal can be avoided.

Please refer to FIG. 2, which is a flow chart of a path handover method according to an embodiment of the present disclosure. The method is performed by a terminal. As shown in FIG. 2, the method can include but is not limited to the following steps.

In step 201, it is determined whether a preset condition is satisfied, in response to an execution of a path handover to a target node being triggered.

In a direct link, the target node is a target cell corresponding to a handover command or a satisfied path handover condition; in an indirect link, the target node is a target relay corresponding to the handover command or the satisfied path handover condition.

Optionally, the terminal being triggered to execute the path handover to the target node may be that the terminal receives a path handover command for handover to the target node sent by a network device; or, the terminal determines that the path handover condition is satisfied based on a channel measurement result.

That is to say, when the terminal receives the path handover command for handover to the target node sent by the network device, it first determines whether a current network environment meets the preset condition. Alternatively, when the terminal determines that the path handover condition is satisfied based on a current channel measurement result, it first judges whether the current network environment meets the preset condition.

The preset condition is a condition used to indicate whether a handover procedure for handover to the target node fails, for example, a success probability of the path handover or a failure probability of the path handover, etc. Additionally, the channel measurement result is used to characterize a current channel quality of the target node. For example, if the target node is the target cell, the channel measurement result can be a reference signal receiving power (RSRP) of the target cell, or a reference signal receiving quality (RSRQ) of the target cell. Alternatively, if the target node is the target relay, the channel measurement result can be a sidelink RSRP or a sidelink RSRQ, etc. The present disclosure does not limit thereto.

Optionally, the terminal may determine whether the preset condition is satisfied based on the current channel measurement result; alternatively, the terminal may also determine whether the preset condition is satisfied using a pre-trained AI model, which is not limited in the present disclosure.

The path handover includes a handover from a direct link to another direct link, a handover from a direct link to an indirect link, a handover from an indirect link to a direct link, or a handover from an indirect link to a direct link, etc.

For example, if the terminal is currently on the direct link, and determines that the target node is a target relay based on the received handover command or the path handover condition, it is triggered to perform the handover from the direct link to the indirect link. Alternatively, if the terminal is currently on the indirect link and determines that the target node is a target cell based on the received handover command or the path handover condition, it is triggered to perform the handover from the indirect link to the direct link.

In step 202, first indication information is sent to the network device, in response to the preset condition being satisfied, in which the first indication information is used to indicate auxiliary information for handover to the target node.

Optionally, the preset condition being satisfied includes determining that the path handover to the target node fails. In addition, the first indication information includes at least one of: an identifier of the target node; a success probability of the path handover; a failure probability of the path handover; a channel measurement result between the terminal and the target node; or path handover failure indication information.

The failure of the path handover to the target node may be determined by the terminal based on the current channel measurement result, or may be determined by the terminal when determining, based on an output of an AI model, that the failure probability of the path handover to the target node is greater than a certain threshold, or may be determined by the terminal when determining, based on the output of the AI model, that the success probability of the path handover to the target node is less than a certain threshold, or may be determined when the failure probability of the path handover to the target node is greater than a certain threshold and the success probability of the path handover to the target node is less than a certain threshold, etc., which will not be limited in the present disclosure.

Optionally, the terminal may determine that the path handover to the target node fails when determining that an output value of a first preset AI model is a preset value. The preset value is a value output by the first preset AI model that indicates a failure handover result.

The first preset AI model is a pre-generated model used to predict whether the path handover of the terminal to the target node corresponding to an input target node identifier will be successful.

Optionally, the terminal may obtain the output value of the first AI model by inputting an identifier of the target node, the current channel measurement result, a channel measurement result within a preset time period prior to a current time, and location information of the terminal into the first preset AI model.

The current channel measurement result may include a measurement result of a current channel between the terminal and the target node, as well as a measurement result of a current channel between the terminal and any of other nodes. Additionally, in order to assess whether the current channel measurement result is suitable for the path handover more accurately, the terminal may also input a channel measurement result within a preset time period prior to the current time into the first preset AI model. For example, a channel measurement result within 10 seconds prior to the current time can be input into the first preset AI model, or the two previous channel measurement results prior to the current time can be input into the first preset AI model, etc., which will be not limited in the present disclosure.

Alternatively, the terminal may also determine that the path handover to the target node fails when a probability value output by a second preset AI model satisfies a preset requirement.

The second preset AI model is a pre-generated model used to predict a probability value of a successful handover or a probability value of a failure handover when the terminal performs the path handover to the target node corresponding to an input target node identifier.

Optionally, the preset requirement may be a preset threshold. For example, the preset requirement may be a probability threshold for the failure handover. When the probability value of the failure handover output by the second preset AI model is greater than the probability threshold for the failure handover, the first indication information needs to be reported. Alternatively, the preset requirement may also be a probability threshold for the successful handover. When the probability value of the successful handover output by the second preset AI model is less than the probability threshold for the successful handover, the first indication information needs to be reported, etc. The present disclosure does not limit there to.

In the present disclosure, the terminal may obtain the probability value output by the second AI model, by inputting the identifier of the target node, the current channel measurement result, the channel measurement result within the preset time period prior to the current time, and the location information of the terminal into the second preset AI model.

Optionally, the terminal may determine the preset requirement according to a protocol agreement, or may determine the preset requirement based on pre-configured configuration information, or may determine the preset requirement based on an indication from the network device, which is not limited in the present disclosure.

Additionally, the network device may use first information to configure different preset requirements for different target nodes, or to configure different preset conditions for nodes with different frequencies.

That is to say, the terminal may determine the preset requirement associated with the identifier of the target node and/or a frequency of the target node, based on the first configuration information sent by the network device.

For example, the first configuration information sent by the network device indicates three preset requirements. Specifically, preset requirement 1 corresponds to frequency range A, preset requirement 2 corresponds to frequency range B, and preset requirement 3 corresponds to frequency range C. When the terminal is triggered to perform the path handover to target node N, it can use the second preset AI model to predict the probability of the failure handover as x, based on the current channel measurement result and previous channel measurement results etc. Since the target node N is located in the frequency range B, it may be determined whether x satisfies the preset requirement 2. If x satisfies the preset requirement 2, the terminal may send the first indication information to the network device. If x does not satisfy the preset requirement 2, it indicates that the probability of the successful handover is relatively high, and the terminal can directly perform the path handover to the target node N.

In the present disclosure, before the handover to the target node, if the terminal determines that the path handover fails, it first sends the first indication information to the network device, to facilitate the network device re-determining the target node or updating a handover condition configuration, thereby avoiding the path handover failure as much as possible.

In the present disclosure, when the terminal is triggered to execute the path handover to the target node, it first determines whether the preset condition is satisfied. If it is determined that the preset condition is satisfied, the terminal sends the first indication information to the network device to indicate the auxiliary information for handover to the target node. In this way, by synchronizing the auxiliary information for handover to the target node with the network device, the path handover failure is avoided, thereby improving the performance of a communication system.

Please refer to FIG. 3, which is a flow chart of another path handover method according to an embodiment of the present disclosure. The method is performed by a terminal. As shown in FIG. 3, the method can include but is not limited to the following steps.

In step 301, it is determined whether a preset condition is satisfied, in response to an execution of a path handover to a target node being triggered.

In step 302, first indication information is sent to the network device, in response to the preset condition being satisfied, in which the first indication information is used to indicate auxiliary information for handover to the target node.

Regarding specific implementation processes of the above steps 301 and 302, reference may be made to the detailed descriptions of any embodiment in the present disclosure, which will not be reiterated here.

In step 303, a preset timer is started.

Optionally, the terminal can start the preset timer when it determines that the preset condition is satisfied or that the first indication information is sent.

In the disclosure, in order to avoid the terminal from failing to report the first indication information, or failing to receive a new indication from the network device in a timely manner, which may affect communication performance, the terminal can start the preset timer upon sending the first indication information or determining that the preset condition is satisfied, to realize timing control of a waiting period for the path handover.

In step 304, a path handover request is initiated to the target node, in response to the preset timer expiring.

In the present disclosure, when the preset timer expires, the terminal may determine that a transmission of the first indication information fails, or that a reception of a new indication from the network device fails. Consequently, the terminal may initiate the path handover request to the target node for realizing the path handover to the target node.

The terminal may determine a timing value of the preset timer base on a protocol agreement, or may determine the timing value based on pre-configured configuration information, or may determine the timing value based on an indication from the network device, etc., which will be limited in the present disclosure.

Optionally, the network device may configure different timers for different target nodes or configure different timers for different frequencies using second configuration information. That is to say, the terminal may determine the preset timer associated with the identifier of the target node and/or a frequency of the target node, based on the second configuration information sent by the network device.

For example, two timers are configured in the second configuration information sent by the network device. Timer 1 corresponds to frequency range A, and timer 2 corresponds to frequency range B. Thus, when the terminal is triggered to perform the path handover to target node N, and the target node N is within the frequency range A, the terminal starts the timer 1 if terminal determines that the preset condition is satisfied. Subsequently, when the timer 1 expires, the terminal may initiate the path handover request to the target node N.

Optionally, the terminal may stop the preset timer, in response to receiving a radio resource control (RRC) reconfiguration message sent by the network device.

The RRC reconfiguration message may be a handover command containing a new target node sent by the network device, or may be information containing a new handover condition configuration sent by the network device, which will be not limited in the present disclosure.

After receiving the RRC reconfiguration message, the terminal may perform the path handover based on the RRC reconfiguration message and simultaneously stop the preset timer.

In the present disclosure, after being triggered to perform the path handover to the target node, the terminal first determines whether the preset condition is satisfied. Upon determining that the preset condition is satisfied, the terminal sends auxiliary information for indicating the handover to the target node to the network device and simultaneously starts the preset timer. When the preset timer expires, the terminal initiates the path handover request to the target node. In this way, by synchronizing the auxiliary information for handover to the target node with the network device, not only the path handover failure is avoided, but also the path handover is initiated within the preset period to avoid unnecessary waiting, thereby improving the performance of the communication system.

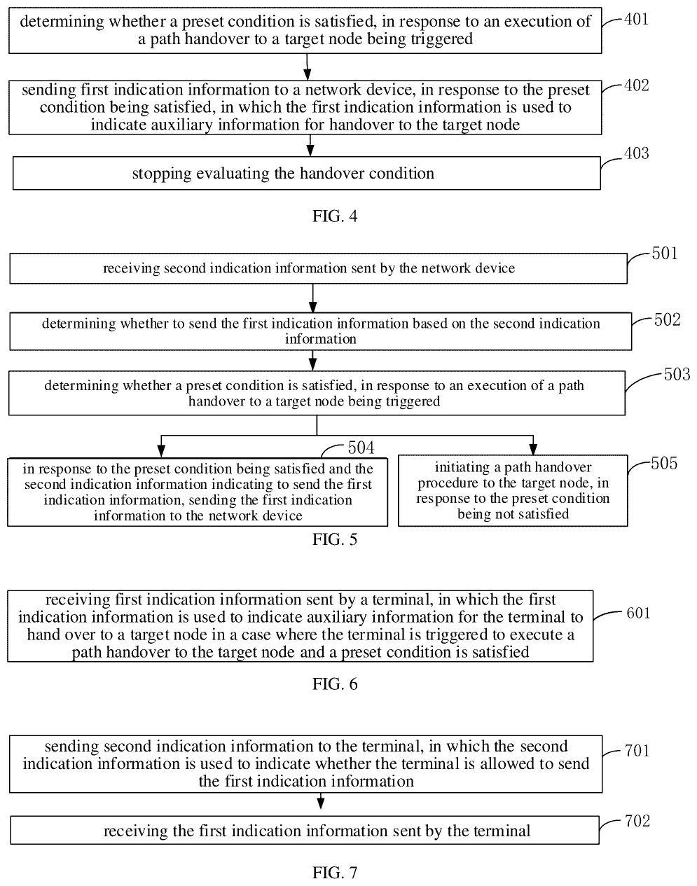

Please refer to FIG. 4, which is a flow chart of another path handover method according to an embodiment of the present disclosure. The method is performed by a terminal. As shown in FIG. 4, the method can include but is not limited to the following steps.

In step 401, it is determined whether a preset condition is satisfied, in response to an execution of a path handover to a target node being triggered.

In step 402, first indication information is sent to the network device, in response to the preset condition being satisfied, in which the first indication information is used to indicate auxiliary information for handover to the target node.

Regarding the specific implementation processes of the above steps 401 and 402, reference may be made to the detailed descriptions of any embodiment in the present disclosure, which will not be reiterated here.

In step 403, an evaluation of the handover condition is stopped.

The handover condition is a condition pre-configured by the network device that may trigger the path handover. For example, the handover condition includes a channel quality condition, a distance condition between the terminal and a node, a time condition, and so on.

In the present disclosure, in order to avoid resource wastage of the terminal, the evaluation of the handover condition is stopped after the first indication information has been sent to the network device.

Optionally, the terminal may also stop evaluating the handover condition upon determining that the preset condition is satisfied, and at the same time, the terminal may send the first indication information to the network device, which will be not limited in the present disclosure.

In the present disclosure, when the terminal is triggered to perform the path handover to the target node, it first determines whether the preset condition is satisfied. If it determines that the preset condition is satisfied, it can send the auxiliary information indicating the handover to the target node to the network device and stop evaluating the handover condition. In this way, by synchronizing the auxiliary information for handover to the target node with the network device and stopping an ineffective evaluation of the handover condition, not only the path handover failure is avoided, but also the resource wastage is also prevented, thereby improving the performance of the communication system.

Please refer to FIG. 5, which is a flow chart of another path handover method according to an embodiment of the present disclosure. The method is performed by a terminal. As shown in FIG. 5, the method can include but is not limited to the following steps.

In step 501, second indication information sent by a network device is received.

In step 502, it is determined whether to send first indication information based on the second indication information.

That is to say, the network device may indicate to the terminal whether the terminal is allowed to report the first indication information when the terminal is triggered to perform a path handover to a target node and a preset condition is satisfied.

Optionally, the terminal may determine whether it can send the first indication information based on a value of a preset field in the second indication information. For example, if the value of the preset field in the second indication information is 1, the first indication information may be sent, and if the value of the preset field in the second indication information is 0, the first indication information may be not sent, etc.

Optionally, the second indication information may indicate to the terminal whether it is allowed to report the first indication information in a case of performing the path handover to any target node and the preset condition being satisfied; alternatively, the second indication information can also indicate to the terminal whether it is allowed to report the first indication information in a case of performing the path handover to different target nodes and the preset condition being satisfied.

Thus, the terminal may determine whether to send the first indication information based on reporting configuration information associated with the target node in the second indication information.

For example, the second indication information includes reporting configuration information 1 associated with Node M, reporting configuration information 2 associated with Node N, and reporting configuration information 3 associated with Node L. Therefore, when the terminal perform the path handover to the Node L, it can determine, based on the reporting configuration information 3, whether to send the first indication information in a case that the preset condition is satisfied.

In step 503, it is determined whether a preset condition is satisfied, in response to an execution of a path handover to a target node being triggered.

The step 503 can be executed simultaneously with steps 501 and 502, or can also be executed before step 502, which is not limited in the present disclosure.

In step 504, the first indication information is sent to the network device, in response to the present condition being satisfied and the second indication information indicating to send the first indication information.

The first indication information is used to indicate auxiliary information for handover to the target node.

In step 505, a path handover procedure is initiated to the target node, in response to the preset condition being not satisfied.

Regarding the specific implementation processes of the above steps 503 to 505, reference may be made to the detailed descriptions of any embodiment in the present disclosure, and thus will not be reiterated here.

It should be noted that if the second indication information indicates that the first indication information is not allowed to be sent in a case of performing the path handover to the target node and the preset condition being satisfied, the terminal can directly initiate the path handover to the target node directly upon the preset condition being satisfied, or may perform the corresponding operations based on other configuration information, which are not limited in the present disclosure.

In the present disclosure, the terminal first receives the second indication information sent by the network device and determines whether it is allowed to send the first indication information based on the second indication information. And then when the terminal is triggered to perform the path handover to the target node, the terminal first determines whether the preset condition is satisfied. If the preset condition is satisfied and the first indication information is allowed to be sent, the terminal can send the first indication information to the network device. In this way, by synchronizing the auxiliary information for handover to the target node with the network device according to an indication of the network device, a path handover failure is avoided, thereby improving the performance of the communication system.

Please refer to FIG. 6, which is a flow chart of another path handover method according to an embodiment of the present disclosure. The method is performed by a network device. As shown in FIG. 6, the method can include but is not limited to the following steps.

In step 601, first indication information sent by a terminal is received, in which the first indication information is used to indicate auxiliary information for the terminal to hand over to a target node in a case where the terminal is triggered to execute a path handover to the target node and a preset condition is satisfied.

In the present disclosure, when the terminal is triggered to perform the path handover to the target node, and the preset condition is satisfied, it can send the auxiliary information for indicating the handover to the target node to the network device. Consequently, the network device may determine whether the handover to the target node will be successful based on the first indication information, and the may determine a new target node or configure a new handover condition for the terminal, thereby avoiding a handover failure.

In a direct link, the target node is a target cell corresponding to a handover command or a satisfied path handover condition; in an indirect link, the target node is a target relay corresponding to the handover command or the satisfied path handover condition.

Additionally, regarding a manner in which the terminal is triggered to execute the path handover to the target node and determines whether the preset condition is satisfied, reference may be made to the detailed descriptions of any embodiment in this disclosure, which will not be reiterated here.

Optionally, the first indication information includes at least one of: an identifier of the target node, a success probability of the path handover, a failure probability of the path handover, and a channel measurement result between the terminal and the target node or path switching failure indication information.

The success probability of the path handover and the failure probability of the path handover may be predicted and determined by the terminal based on current network environment information, such as the channel measurement result and location information of the terminal, using a preset AI model. The channel measurement result is used to characterize a current channel quality of the target node. For example, if the target node is a target cell, the channel measurement result can be a reference signal receiving power (RSRP) of the target cell, or a reference signal receiving quality (RSRQ) of the target cell. Alternatively, if the target node is a target relay, the channel measurement result can be a sidelink RSRP or a sidelink RSRQ, etc. The present disclosure does not limit there to.

Optionally, the terminal may determine that the preset condition is satisfied and thus send the first indication information when an output of the AI model meets a preset requirement. The preset requirement may be configured by the network device for the terminal, or may be pre-set in the terminal or may be determined by the terminal based on a protocol agreement.

That is to say, the network device may send first configuration information to the terminal, in which the first configuration information is used to configure the preset requirement to the terminal.

Optionally, the preset requirement may be a threshold. The first configuration information may configure only one preset requirement, so that the terminal may send the first indication information to the network device when it performs the path handover to any target node, as long as it determines that the threshold is satisfied.

Alternatively, the first configuration information may also configure multiple preset requirements associated with different nodes or different frequencies, respectively. In this case, when the terminal performs the path handover to the target node, it first determines the threshold associated with an identifier of the target node and/or a frequency of the target node, based on the first configuration information. And the terminal then sends the first indication information only if the associated threshold is satisfied.

Additionally, in order to avoid that the terminal waits indefinitely for an indication from the network device after sending the first indication information to the network device, which could affect communication performance, the network device in the present disclosure may configure a timer for the terminal, so that the terminal may stop waiting and initiate a path handover procedure when the timer expires.

That is to say, the network device can send second configuration information to the terminal, in which the second configuration information is used to configure the preset timer for the terminal.

Optionally, the second configuration information may be used to configure only one preset timer. That is to say, when the terminal performs the path handover to any target node, it determines whether to initiate the path handover procedure based on this timer, either when the preset condition is satisfied or the first indication information is sent.

Alternatively, the second configuration information can also be used to configure multiple timers associated with different nodes or different frequencies, respectively, so that when the terminal performs the path handover to the target node, it first determines the preset timer associated with the identifier of the target node and/or the frequency of the target node based on the second configuration information. And the terminal then initiates the path handover procedure to the target node only when the preset timer expires.

In the present disclosure, when the terminal is triggered to hand over to the target node and the preset condition is satisfied, it sends the first indication information to the network device to indicate auxiliary information for handover to the target node. In this way, by synchronizing the auxiliary information for the terminal to hand over to the target node, a path handover failure is avoided, thereby improving the performance of the communication system.

Please refer to FIG. 7, which is a flow chart of another path handover method according to an embodiment of the present disclosure. The method is performed by a network device. As shown in FIG. 7, the method can include but is not limited to the following steps.

In step 701, second indication information is sent to a terminal, in which the second indication information is used to indicate whether the terminal is allowed to send first indication information.

In the disclosure, in order to avoid the waste of channel resources caused by the terminal sending the first indication information, the network device may also send the second indication information to the terminal to indicate whether the terminal is allowed to report the first indication information.

Optionally, the network device may determine whether the first indication information can be sent based on a value of a preset field in the second indication information. For example, if the value of the preset field in the second indication information is 1, the first indication information can be sent, and if the value of the preset field in the second indication information is 0, the first indication information is not allowed to be sent, etc.

Optionally, the second indication information may indicate to the terminal whether it is allowed to report the first indication information in a case of performing the path handover to any target node and the preset condition being satisfied; alternatively, the second indication information may also indicate to the terminal whether it is allowed to report the first indication information in a case of performing the path handover to different target nodes and the preset condition being satisfied.

That is to say, the second indication information may contain reporting configuration information associated with the target node. Thus, the terminal may determine whether to send the first indication information based on the reporting configuration information associated with the target node in the second indication information.

In step 702, first indication information sent by the terminal is received.

The first indication information is sent by the terminal when the terminal is triggered to perform the path handover to the target node, the preset condition is satisfied, and the second indication information indicates that the first indication information is allowed to be sent. The first indication information is used to indicate auxiliary information for handover to the target node.

Regarding the specific implementation of the above step 702, reference may be made to the detailed description of any embodiment in the present disclosure, which will not be reiterated here.

In the present disclosure, the network device first sends the second indication information to the terminal to indicate whether it is allowed to report the first indication information. Subsequently, if the network device permits the terminal to report the first indication information, it can receive the first indication information sent by the terminal. In this way, by instructing the terminal to synchronize the auxiliary information for handover to the target node, the path handover failure is avoided, thereby improving the performance of the communication system.

Please refer to FIG. 8, which is a block diagram of a communication apparatus according to an embodiment of the present disclosure. The communication apparatus 800 shown in FIG. 8 can include a processing module 801 and a transceiver module 802. The transceiver module 802 can include a transmitting module and/or a receiving module. The transmitting module is used to implement a transmitting function, and the receiving module is used to implement a receiving function. The transceiver module 802 can implement the transmitting function and/or the receiving function.

It can be understood that the communication apparatus 800 can be a terminal, an apparatus within the terminal or an apparatus that can be used in conjunction with the terminal.

The communication apparatus 800 is on a terminal side.

The processing module 801 is configured to determine whether a preset condition is satisfied, in response to an execution of a path handover to a target node being triggered.

The transceiver module 802, is configured to send first indication information to a network device in response to the preset condition being satisfied, in which the first indication information is used to indicate auxiliary information for handover to the target node.

Optionally, the processing module 801 is further configured to:
determine that a path handover command of the path handover to the target node sent by the network device is received; or
determine that a path handover condition is satisfied.

Optionally, the preset condition being satisfied includes: determining that the path handover to the target node fails.

Optionally, the processing module 801 is further configured to:
determine that the path handover to the target node fails, in response to an output value of a first preset AI model being a preset value; or
determine that the path handover to the target node fails, in response to a probability value output by a second preset AI model satisfying a preset requirement.

Optionally, the processing module 801 is further configured to:
input an identifier of the target node, a current channel measurement result, a channel measurement result within a preset time period prior to a current time, and location information of the terminal into the first preset AI model, and obtain the output value of the first AI model; or
input the identifier of the target node, the current channel measurement result, the channel measurement result within the preset time period prior to the current time, and the location information of the terminal into a second preset AI model, and obtain a probability value output by the second AI model.

Optionally, the processing module 801 is further configured to:
determine that the preset condition is satisfied or that the first indication information is sent, and start a preset timer;
initiate a path handover request to the target node, in response to the preset timer expiring.

Optionally, the processing module 801 is further configured to:
stop the preset timer, in response to receiving a radio resource control (RRC) reconfiguration message sent by the network device.

Optionally, the processing module 801 is further configured to:
determine the preset requirement associated with the identifier of the target node and/or a frequency of the target node, based on first configuration information sent by the network device; or
determine the preset timer associated with the identifier of the target node and/or the frequency of the target node, based on second configuration information sent by the network device.

Optionally, the processing module 801 is further configured to:
stop evaluating a switching condition, in response to determining that the preset condition is satisfied; or
stop evaluating the handover condition, in response to the first indication information being sent.

Optionally, the transceiver module 802 is further configured to:
receive second indication information sent by the network device.

The processing module 801 is further configured to determine whether to send the first indication information based on the second indication information.

Optionally, the processing module 801 is further configured to:
determine whether to send the first indication information based on reporting configuration information associated with the target node in the second indication information.

Optionally, the first indication information includes at least one of: an identifier of the target node, a success probability of the path handover, a failure probability of the path handover, a channel measurement result between the terminal and the target node, or path handover failure indication information.

Optionally, the processing module 801 is further configured to:
initiate a path handover procedure to the target node, in response to the preset condition being not satisfied.

In the present disclosure, when the terminal is triggered to execute the path handover to the target node, it first determines whether the preset condition is satisfied. If it is determined that the preset condition is satisfied, the terminal sends the first indication information to the network device to indicate the auxiliary information for handover to the target node. In this way, by synchronizing the auxiliary information for handover to the target node with the network device, a path handover failure is avoided, thereby improving the performance of a communication system.

Alternatively, the communication apparatus 800 is on the network device side.

The transceiver module 802 is configured to receive first indication information sent by a terminal, in which the first indication information is used to indicate auxiliary information for the terminal to hand over to a target node in a case where the terminal is triggered to execute a path handover to the target node and a preset condition is satisfied.

Optionally, the transceiver module 802 is further configured to:
send first configuration information to the terminal, in which the first configuration information is used to configure a preset requirement for the terminal; or
send second configuration information to the terminal, in which the second configuration information is used to configure a preset timer for the terminal.

Optionally, the transceiver module 802 is further configured to:
send second indication information to the terminal, in which the second indication information is used to indicate whether the terminal is allowed to send the first indication information.

Optionally, the second indication information includes reporting configuration information associated with the target node.

Optionally, the first indication information includes at least one of: an identifier of the target node, a success probability of the path handover, a failure probability of the path handover, and a channel measurement result between the terminal and the target node, or path handover failure indication information.

In the present disclosure, when the terminal is triggered to hand over to the target node and the preset condition is satisfied, it sends the first indication information to the network device to indicate the auxiliary information for handover to the target node. In this way, by synchronizing the auxiliary information for the terminal to hand over to the target node, a path handover failure is avoided, thereby improving the performance of the communication system.

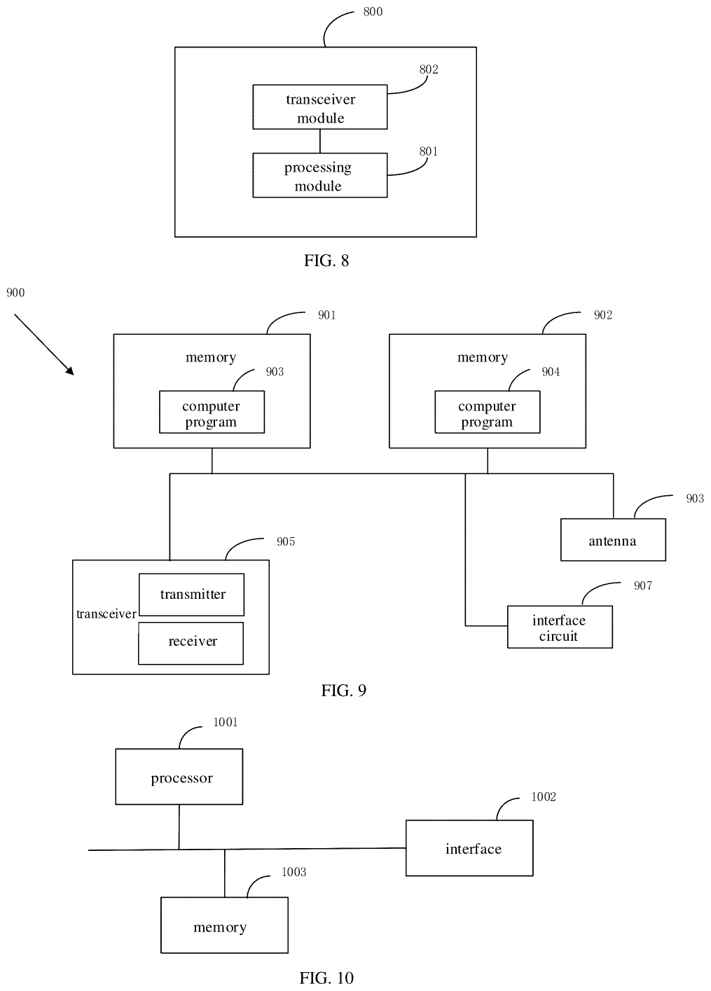

Please refer to FIG. 9, which is a block diagram of another communication apparatus according to an embodiment of the present disclosure. The communication apparatus 900 may be a terminal, or a chip, a chip system, or a processor that supports the terminal to implement the above methods. This apparatus may be used to implement the methods described in the above method embodiments, which can be referred to in the description of the above method embodiments.

The communication apparatus 900 may include one or more processors 901. The processor 901 may be a general-purpose processor or a dedicated processor, etc. For example, it may be a baseband processor or a central processing unit. The baseband processor may be used to process a communication protocol and communication data. The central processing unit may be used to control the communication apparatus (such as a base station, a baseband chip, a terminal, a terminal chip, a DU or a CU, etc.) to execute a computer program, and process data from the computer program.

Optionally, the communication apparatus 900 may also include one or more memories 902, which may store a computer program 904. The processor 901 executes the computer program 904, thereby enabling the communication apparatus 900 to perform the methods described in the above method embodiments. Optionally, the memory 902 may also store data. The communication apparatus 900 and the memory 902 may be set up separately or integrated together.

Optionally, the communication apparatus 900 may also include a transceiver 905 and an antenna 906. The transceiver 905 may be referred to as a transceiver unit, a transceiver machine, or a transceiver circuit, etc., which is used to implement the receiving and transmitting functions. The transceiver 905 may include a receiver and a transmitter. The receiver may be referred to as a receiving machine or a receiving circuit, etc., which is used to implement the receiving function; the transmitter may be referred to as a transmitting machine or a transmitting circuit, etc., which is used to implement the transmitting function.

Optionally, the communication apparatus 900 may also include one or more interface circuits 907. The interface circuit 907 is used to receive a code instruction and transmit it to the processor 901. The processor 901 runs the code instruction to enable the communication apparatus 900 to perform the methods described in the above method embodiments.

When the communication apparatus 900 is a terminal, the transceiver 905 is used to perform the transmitting and receiving steps shown in FIG. 2 to 5, and the processor 901 is used to perform the processing steps shown in FIG. 2 to 5.

When the communication apparatus 900 is a network device, the transceiver 905 is used to perform the transmitting and receiving steps shown in FIG. 6 to 7, and the processor 901 is used to perform the processing steps shown in FIG. 6 to 7.

In an implementation, the processor 901 may include a transceiver for realizing the receiving and transmitting functions. For example, the transceiver can be a transceiver circuit, an interface, or an interface circuit. The transceiver circuit, the interface, or the interface circuit used to realize the receiving and transmitting functions can be separate or integrated together. The aforementioned transceiver circuit, the interface, or the interface circuit can be used for reading and writing code/data, or the aforementioned transceiver circuit, the interface, or the interface circuit may be used for signal transmission or transfer.

In an implementation, the processor 901 may store a computer program 903. When the computer program 903 runs on the processor 901, the communication apparatus 900 may be caused to perform the methods described in the above method embodiments. The computer program 903 may be solidified in the processor 901. In this case, the processor 901 may be implemented by hardware.

In an implementation, the communication apparatus 900 may include a circuit that can implement the functions of transmitting, receiving, or communicating as described in the aforementioned method embodiments. The processor and the transceiver described in the present disclosure can be implemented on an integrated circuit (IC), an analog IC, a radio frequency integrated circuit (RFIC), a mixed-signal IC, an application specific integrated circuit (ASIC), a printed circuit board (PCB), an electronic device, etc. The processor and transceiver can also be manufactured using various IC process technologies, such as complementary metal oxide semiconductor (CMOS), nMetal-oxide-semiconductor (NMOS), positive channel metal oxide semiconductor (PMOS), bipolar junction transistor (BJT), bipolar CMOS (BiCMOS), silicon germanium (SiGe), gallium arsenide (GaAs), etc.

The communication apparatus described in the above embodiments can be a network device or an intelligent relay, but the scope of the communication apparatus described in the present disclosure is not limited to this, and the structure of the communication apparatus is not restricted to FIG. 9. The communication apparatus may be an independent device or a part of a larger device. For example, the communication apparatus can be:
(1) an independent integrated circuit (IC), a chip, or a chip system or a subsystem;
(2) a collection with one or more ICs, optionally, this collection with one or more ICs can also include a storage component for storing data and computer programs;
(3) an ASIC, such as a modem;
(4) a module that can be embedded in other devices;
(5) a receiver, terminal, intelligent terminal, cellular phone, wireless device, handheld device, mobile unit, vehicular device, network device, cloud device, artificial intelligence device, etc.;
(6) others, etc.

For the case where the communication apparatus may be the chip or the chip system, reference may be made to a block diagram of a chip shown in FIG. 10. The chip shown in FIG. 10 includes a processor 1001 and an interface 1002. The number of the processors 1001 can be one or more, and the number of the interfaces 1002 can be multiple.

For the case where the chip is used to implement the functions of the terminal in the embodiments of the present disclosure.

Optionally, the chip also includes a memory 1003, which is used to store necessary computer programs and data.

Those skilled in the art may also understand that the various illustrative logical blocks and steps listed in the embodiments of the present disclosure may be implemented by electronic hardware, computer software, or their combination. Whether such a function is implemented in hardware or software depends on specific applications and design requirements of the overall system. Those skilled in the art may, for each specific application, use a variety of methods to achieve the above function, but such implementation shall not be regarded as going beyond the scope of the protection of the embodiments of the present disclosure.

In the embodiments of the present disclosure, a computer program product is provided. When the computer program product is executed by a computer, the function of any one of the above method embodiments is performed.

The present disclosure also provides a computer program product, which, when executed by a computer, implements the functions of any of the above method embodiments.

In the above embodiments, the functions may be wholly or partially implemented by software, hardware, firmware, or any combination of them. When implemented by software, the functions may be implemented in whole or in part in the form of a computer program product. The computer program product includes one or more computer programs. Procedures or functions according to embodiments of the present disclosure are wholly or partially generated when the computer program is loaded and executed on a computer. The computer may be a general purpose computer, a special purpose computer, a computer network, or other programmable device. The computer program may be stored in a computer-readable storage medium or transmitted from one computer-readable storage medium to another. For example, the computer program may be transmitted from one website, computer, server, or data center to another website, computer, server, or data center via wire (such as a coaxial cable, a fiber optic, a digital subscriber line (DSL)) or wireless (such as infrared, wireless, microwave). The computer-readable storage medium may be any available medium that may be accessed by a computer, or a data storage device such as a server that integrates one or more of the available media, and a data center. The available medium media be a magnetic medium (such as a floppy disk, a hard disk and a magnetic tape), an optical medium (such as a digital video disk (DVD)), or a semiconductor medium (such as a solid state disk (SSD)).

Those skilled in the art may understand that numbers like “first” and “second” in the present disclosure are only for the convenience of description, and are not used to limit the scope of the embodiments of the present disclosure, and also indicate a sequential order.

The term “at least one” in the present disclosure may also be described as one or more, and the more may be two, three, four, or more, which is not limited in the present disclosure. In the embodiment of the present disclosure, for a technical feature, the technical feature in the technical features are distinguished by terms “first”, “second”, “third”, “A”, “B”, “C” and “D”, etc., and the technical features described by the terms “first”, “second”, “third”, “A”, “B”, “C”and “D”, etc. are not in a sequential order or in an order of size.

Corresponding relationships indicated by tables in the present disclosure may be configured or predefined. Values of information in the tables are only examples, and may be configured as other values, which are not limited in the disclosure. When the corresponding relationship between information and parameters is configured, it is not always necessary to configure all corresponding relationships indicated in tables. For example, in the tables of the present disclosure, corresponding relationships indicated by some rows may not be configured. For another example, appropriate transformations and adjustments, such as splitting and merging, may be made based on the above tables. Names of parameters shown in headers of the tables may be other names understandable by the communication apparatus, and values or representations of the parameters may be other values or representations understandable by the communication apparatus. When the above tables are implemented, other data structures may be used, for example, arrays, queues, containers, stacks, linear lists, pointers, linked lists, trees, graphs, structures, classes, heaps or hash tables may be used.

Predefined in the disclosure may be understood as defined, predefined, stored, pre-stored, pre-negotiated, pre-configured, solidified or pre-fired.

Those skilled in the related art may realize that, in combination with units and algorithm steps of the examples described in embodiments of the present disclosure, may be implemented by an electronic hardware or a combination of an electronic hardware and a computer software. Whether the functions are executed by the hardware or the software depends on a specific application and a design constraint of the technical solutions. Those skilled in the art may adopt different methods for each specific application to implement the described functions, but such implementation should not be considered as going beyond the scope of the present disclosure.

Those skilled in the art may clearly understand that, a specific working process of a system, an apparatus and a unit described above may refer to a corresponding process in the above method embodiments, which will not be repeated here.

The above are only implementations of the disclosure. However, the protection scope of the disclosure is not limited here. Changes and substitutions that may be easily considered by those skilled in the art shall be contained within the protection scope of the present disclosure. Therefore, the protection scope of the disclosure shall be subject to the protection scope of claims.

1. A path handover method, performed by a terminal device, comprising:
determining whether a preset condition is satisfied, in response to an execution of a path handover to a target node being triggered;
sending first indication information to a network device, in response to the preset condition being satisfied, wherein the first indication information is used to indicate auxiliary information for handover to the target node.

2. The method according to claim 1, wherein the execution of the path handover to the target node being triggered comprises one of:
determining that a path handover command of the path handover to the target node sent by the network device is received; or
determining that a path handover condition is satisfied.

3. The method according to 1, wherein the preset condition being satisfied, comprises:
determining that the path handover to the target node fails.

4. The method according to claim 3, wherein determining that the path handover to the target node fails comprises:
determining that the path handover to the target node fails, in response to an output value of a first preset artificial intelligence (AI) model being a preset value; or
determining that the path handover to the target node fails, in response to a probability value output by a second preset AI model satisfying a preset requirement.

5. The method according to claim 4, further comprising:
inputting an identifier of the target node, a current channel measurement result, a channel measurement result within a preset time period prior to a current time, and location information of the terminal device, into the first preset AI model, and obtaining the output value of the first preset AI model; or
inputting the identifier of the target node, the current channel measurement result, the channel measurement result within the preset time period prior to the current time, and the location information of the terminal device, into the second preset AI model, and obtaining a probability value output by the second preset AI model.

6. The method according to claim 1, further comprising:
determining that the preset condition is satisfied or that the first indication information is sent, and starting a preset timer;
initiating a path handover request to the target node, in response to the preset timer having expired.

7. The method according to claim 6, further comprising:
stopping the preset timer, in response to receiving a radio resource control (RRC) reconfiguration message sent by the network device.

8. The method according to claim 4, further comprising:
determining the preset requirement associated with at least one of the identifier of the target node or a frequency of the target node, based on first configuration information sent by the network device; or
determining the preset timer associated with at least one of the identifier of the target node or the frequency of the target node, based on second configuration information sent by the network device.

9. The method according to claim 1, further comprising one of:
stopping evaluating a handover condition, in response to determining that the preset condition is satisfied; or
stopping evaluating the handover condition, in response to the first indication information being sent.

10. The method according to claim 1, further comprising:
receiving second indication information sent by the network device;
determining whether to send the first indication information based on the second indication information.

11. The method according to claim 10, wherein determining whether to send the first indication information based on the second indication information comprises:
determining whether to send the first indication information based on reporting configuration information associated with the target node in the second indication information.

12. The method according to claim 1, wherein the first indication information comprises at least one of:
an identifier of the target node;
a success probability of the path handover;
a failure probability of the path handover;
a channel measurement result between the terminal device and the target node; or path handover failure indication information.

13. The method according to claim 1, further comprising:
initiating a path handover procedure to the target node, in response to the preset condition being not satisfied.

14. A path handover method, performed by a network device, comprising:
receiving first indication information sent by a terminal device, wherein the first indication information is used to indicate auxiliary information for the terminal to hand over to a target node in a case where the terminal is triggered to execute a path handover to the target node and a preset condition is satisfied.

15. The method according to claim 14, further comprising one of:
sending first configuration information to the terminal device, wherein the first configuration information is used to configure a preset requirement for the terminal; or
sending second configuration information to the terminal device, wherein the second configuration information is used to configure a preset timer for the terminal.

16. The method according to claim 14, further comprising:
sending second indication information to the terminal device, wherein the second indication information is used to indicate whether the terminal device is allowed to send the first indication information.

17. The method according to claim 16, wherein the second indication information comprises reporting configuration information associated with the target node.

18. The method according to claim 14, wherein the first indication information comprises at least one of:
a target node identifier;
a success probability of the path handover;
a failure probability of the path handover;
a channel measurement result between the terminal and the target node; or
path handover failure indication information.

19-21. (canceled)

22. A terminal device, comprising a processor and a memory, wherein the memory stores computer programs, and when the computer programs stored in the memory are executed by the processor, the processor is configured to:
determine whether a preset condition is satisfied, in response to an execution of a path handover to a target node being triggered;
send first indication information to a network device, in response to the preset condition being satisfied, wherein the first indication information is used to indicate auxiliary information for handover to the target node.

23. (canceled)

24. A network device, comprising a processor and a memory, wherein the memory stores computer programs, and when the computer programs stored in the memory are executed by the processor, the processor is configured to perform the method according to claim 14.
